(19) United States
(12) Patent Application Publication
(10) Pub. No.: US 2015/0053067 A1
(43) Pub. Date: Feb. 26, 2015

(54) PROVIDING MUSICAL LYRICS AND MUSICAL SHEET NOTES THROUGH DIGITAL EYEWEAR

(71) Applicant: Michael Goldstein, Los Angeles, CA (US)

(72) Inventor: Michael Goldstein, Los Angeles, CA (US)

(21) Appl. No.: 14/465,806

(22) Filed: Aug. 21, 2014

Related U.S. Application Data
(60) Provisional application No. 61/868,536, filed on Aug. 21, 2013.
(60) Provisional application No. 61/869,970, filed on Aug. 26, 2013.

(51) Int. Cl. G02C 11/00; G10H 1/36; G10H 1/00

(52) U.S. Cl. CPC G02C 11/10; G10H 1/0008; G10H 1/361; G10H 2220/011; G10H 2220/015
USPC 84/609

(57) ABSTRACT

Described herein is an optical device for presenting music information. The optical device identifies an indication that a music piece is to begin playback. The optical device identifies music information associated with the music piece. The optical device presents the music information in synchronization with playback of the music piece.

### CLAIM OF PRIORITY

This application claims priority to U.S. Provisional Patent Application No. 61/868,536, filed Aug. 21, 2013 and U.S. Provisional Patent Application No. 61/869,970, filed Aug. 26, 2013, which both are herein incorporated by reference.

### TECHNICAL FIELD

Implementations of the present disclosure relate to digital eyewear, and more specifically, to providing musical information to a user through digital eyewear.

### BACKGROUND

Throughout history music has served as an enduring form of entertainment for many people. People often enjoy listening, singing along with and performing music in an array of forms including writing musical notes, singing along, playing instruments and creating their own tunes and vocals. As technology continues to advance, there may be additional ways that people can continue to enjoy music.

### BRIEF DESCRIPTION OF THE DRAWINGS

The present disclosure is illustrated by way of example, and not by way of limitation, in the figures of the accompanying drawings.

FIG. 1 illustrates an example system architecture, in accordance with some embodiments.

FIG. 2 illustrates a display of musical lyrics and musical notes through digital eyewear, in accordance with some embodiments.

FIG. 3 illustrates an optical lens with musical notes displayed being read from the software being displayed through the lens, and the capabilities of how the musicals information is gathered, in accordance with some embodiments.

FIG. 4 illustrates a musician playing a musical instrument, and reciting notes while wearing a digital lens, in accordance with some embodiments.

FIG. 5 illustrates a singer wearing an optical lens that allows access to software that streams musical lyrics while the user performs, in accordance with some embodiments.

FIG. 6 illustrates a user using software to stream musical lyrics for gaming purposes and to entertain friends through a karaoke sing along, in accordance with some embodiments.

FIG. 7 is a flow diagram illustrating a method for providing musical information in an optical display, in accordance with some embodiments.

FIG. 8 is a block diagram illustrating an example computer system, according to some embodiments.

FIG. 9 illustrates an example view through a lens, according to some embodiments.

### DETAILED DESCRIPTION

Described herein is a mechanism for presenting musical information in an optical display (e.g., digital eyewear). Conventionally, musicians have used paper-based sheet music to read and perform music. They often read and recite notes from the paper-based sheet music to guide their performances. In some situations, such as where musicians have may have more than one instrument to practice or play at a time, the sheet music may be confusing or a burden to switch pages and disrupt the tempo or flow of music. This may cause the musician to lose track of the position of the composition or may hinder his/her performance. Further, musicians who are visually impaired may have some difficulty with conventional sheet music. Conventional karaoke typically includes a performer that sings into a microphone while reading lyrics from a large display, such as a television. Some karaoke systems present lyrics to the performer using a tablet or other mobile device. There are several drawbacks, however, to conventional sheet music and karaoke systems. For example, some visually impaired individuals may have some degree of difficulty seeing music and/or lyrics that are presented on a screen. Additionally, sometimes the tone and tempo of the music can be out of synchronization with the pronunciation of the lyrics or music. Moreover, using conventional paper-based sheet music or karaoke systems, performers are limited in their ability to look anywhere other than in the direction of the music stand or screen that is presenting the lyrics.

Implementations of the present disclosure address the above and other deficiencies of conventional systems by providing a wearable optical display that presents musical information via one or more lenses. Performers may use the optical display to perfect their talents and abilities and find new methods to practice skills, entertain themselves and others, and ways to transmit data. The optical display may include any type of transparent or translucent lens made of acrylic, plastic, glass, crystal, etc. The optical display may include software that controls the presentation of musical information via the one or more lenses to a performer (e.g., musicians, singers). The musical information includes musical lyrics and musical notes that may be presented via the optical display.

Performers may benefit from the optical display by because it includes close up display of musical notes on a music sheet or on the lens. Performers can use the optical display for performances and the optical display provide enhanced mobility for an on-stage performer, especially when they it is used in conjunction with a wireless microphone or a free-standing musical instrument. The optical display may also receive updates to the musical notes and lyrics, such as via a network connection. For example, a performer may take advantage of the optical display's ability to receive updates by changing songs before or during a performance. In addition to presenting lyrics, the optical display may also analyze a performer's voice patterns, lyric speed, enunciation, and/or tone to help the singer practice and perfect his voice to accurately sing out the lyrics at the right pace and sound levels. Using the optical display, students may also have more capabilities to practice and have live software updates from an instructor or the ability to customize notes and music to help teach the student. Others who can benefit include those who are interested in knowing the lyrics to a song, who like to sing along with a song, who are interested in a closed caption display of information or for reading captions from close sight. The proximity and ability to have a program that interacts and is intuitive for live musical updates is a revolutionary advancement in the musical world which has been hindered by the lack of digital musical program technology.

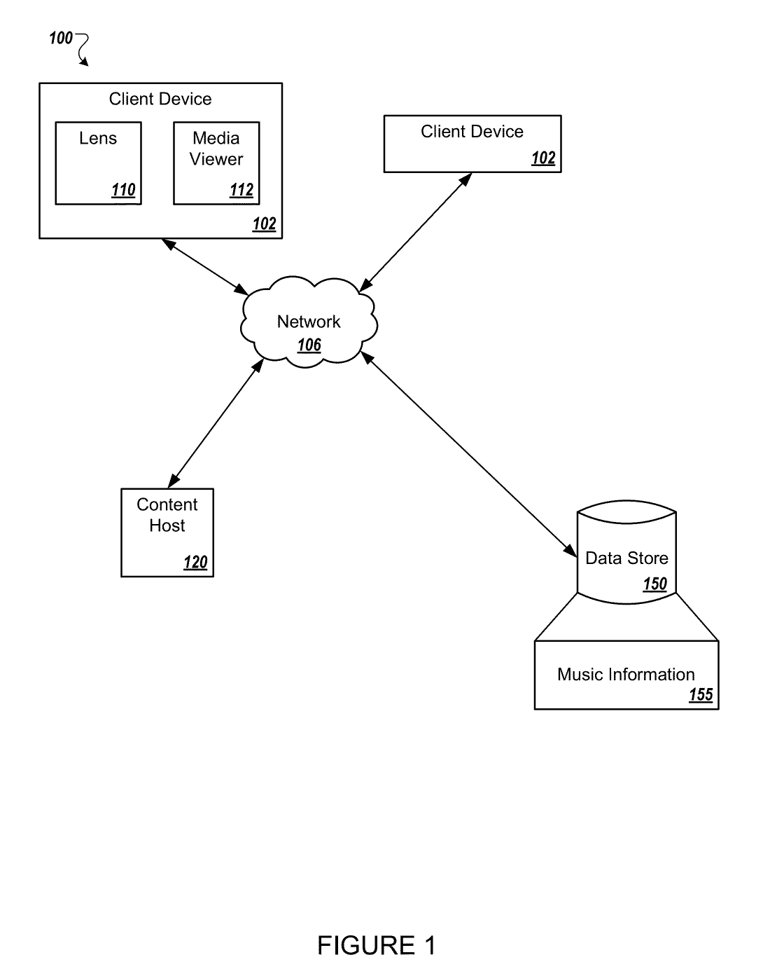

FIG. 1 illustrates an example system architecture 100, in accordance with one implementation of the disclosure, for providing music information on an optical device. The system architecture 100 includes any number of client devices 102, a network 106, and a data store 150.

The one or more client devices 102 may each include computing devices such as a wearable device, optical eyewear, and the like. The client device 102 includes a transparent or translucent lens 110. Example lenses 110 include an eyeglasses lens, a contact lens, transparent glass, iOptiks contact lens from Innovega Inc. of Bellevue, Wash., sun glasses, or any other eyepiece that may be worn by an individual.

The lens 110 may include a presentation component that may present data to the user. For example, the lens 110 may present music information pertaining to a music piece to a user who is performing the music piece. The music information can include any information or data that is related to the music piece, such as lyrics, notes, chords, rhythm, beat, original artist information, composer information, performing artist information, etc. The presentation component may be a translucent display or LED, LCD, or OLED technology or any transparent, semi-transparent or translucent display. The presentation component may be embedded within the lens 110. Alternatively, the presentation component may be coupled to an outer portion of the lens 110. In some embodiments, the client device 102 includes an optical device (e.g., glasses, contact lenses) that are in communication with another client device 102, such as a personal computers (PC), laptop, mobile phone, smart phone, tablet computer, netbook computer, etc. In some implementations, client device 102 may also be referred to as a “user device.”

In one implementation, network 106 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In one implementation, the data store 150 may be a memory (e.g., random access memory), a cache, a drive (e.g., a hard drive), a flash drive, a database system, or another type of component or device capable of storing data. The data store 150 may also include multiple storage components (e.g., multiple drives or multiple databases) that may also span multiple computing devices (e.g., multiple server computers). The data store 150 may include music information 155.

In one implementation, the system 100 includes a content host 120 that may provide music information 155 (e.g., lyrics, digital sheet music, etc.) to the client device 102. The content host 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the content host 120 may allow a user to consume, upload, search for, music information. The content host 120 may also include a website (e.g., a webpage) that may be used to provide a user with access to the music information. The content host 120 may include any type of content delivery network providing access to content and/or media items and can include a social network, a news outlet, a media aggregator, a chat service, a messaging platform, and the like.

Each client device 102 includes a media viewer 112. In one implementation, the media viewer 112 may be an application that allows users to consume content and media items, such as images, videos, web pages, documents, music information, lyrics, digital sheet music, etc. For example, the media viewer 112 may be a web browser that can access, retrieve, present, and/or navigate content (e.g., web pages such as Hyper Text Markup Language (HTML) pages, digital media items, etc.) served by a web server. The media viewer 112 may render, display, and/or present the content (e.g., a web page, a media item presentation component) to a user. In another example, the media viewer 112 may be a standalone application that allows users to view digital music information (e.g., sheet music, lyrics, emoticons, an equalizer, digital cords, music tempo, lyric pronunciation, etc. The media viewer 112 may be provided to the client devices 102 by a server (not shown) and/or the content host 120. For example, the media viewer 112 may include one or more embedded media players that are embedded in web pages provided by the content host 120. In another example, the media viewer 112 may be an application that is downloaded from the server.

A client device 102 can receive music information from any source, such as from the content host 120. Other examples of music information 155 sources include a recorder on the client device 102, another client device, a smart watch, computer, optical device, wireless transmitter, wired transmitter, smart CPU headphones, smart instrument with an on-board CPU, etc. The music information 155 may be part of an interface document that can be interpreted by the media viewer 112 on client device 102. The interface document can be any type of electronic document. In some implementations, the interface document is a navigable document where some of the document is visible in a user interface while another portion of the electronic document is not currently visible in the user interface but may become visible based on user input. For example, upon a user activation of a scrolling mechanism (e.g., via a scrollbar, a scroll wheel, a touchscreen movement, automatic scrolling, eye looking up or down, etc.), different portions of the interface document can become visible while other portions can become no longer visible. The interface document can include one or more portions that can be scrollable vertically, horizontally, or a combination thereof. Examples of interface documents include a web page or a mobile app user interface document presenting a stream of music information. In some embodiments, the interface document scrolls synchronously with a playing music track.

In operation, the media viewer 112 can present music information to a user via the lens 110. The media viewer 112 may present a user interface that includes at least one selectable musical item (e.g., a song). A performer may provide input via the user interface to select the musical item. Once the musical item is selected, the media viewer 112 may present musical information (e.g., notes, lyrics) associated with the selected musical item. The media viewer 112 may retrieve the musical information from a local storage or from a remote storage, such as a content host 120. In some embodiments, the media viewer 112 is controllable via voice or stationary controls through the lens 110, or from a separate computing device such as a smart phone, tablet, computer, laptop, smart watch, or other control command post, or a smart instrument (e.g., a smart piano, smart violin) that includes controls for the media viewer 112 and/or for the client device 102 that includes the media viewer 112. Example controls for the media viewer 112 include song selection, set a random presentation order, pause the lyrics or sheet music, fast forward, reversed, speed controls, etc. In embodiments, the performer can control the speed or amount of lyrics or notes to skip to and control a skip interval (forward or backward), such as by one lyric, beat, meter or note at a time, or by any other interval. The user many also adjust the display speed, such as to 1×2×, 3×4×5× or greater or slower speed.

In some embodiments, the client device 102 saves a paused location so the performer does not lose track of the place in time of singing or performance.

In some embodiments, the client device 102 stores the performance (e.g., singing, playing of an instrument) of the performer. The client device 102 can store the performance locally or can transmit a data file of the performance, such as via network 106, to another device for storage and retrieval. At a later point in time, the performer may provide a request to play the performance, measure voice or instrument analytics, measure word pronunciation, compare music with other singers or performers, send song to social media or a communication device, delete song recording, or compare song to a different performance that was previously saved or simply stop the track without any feedback.

Presenting the music information through the lens may also provide a layer of protection because only the individual wearing the glasses may see the music information. A musician or singer may protect the line of sight of their lyrics or notes and keep the information confidential.

In some embodiments, the client device 102 may control the tempo or the speed at which the notes are displayed so the performer can keep the music on pace. In some embodiments, the client device 102 may control tempo, lyric order, sheet music order and customize patterns and lyrics and interacting with the client device 102.

In some embodiments, the client device 102 may permit a user to purchase music or sell music created using the client device 102. In some embodiments, the client device 102 syncs to instruments that have computing or smart technologies. In some embodiments, the client device 102 syncs music with other smart devices to stream in harmony and in sync at the same time. In some embodiments, the client device 102 interacts and syncs with smart or sophisticated headphones to sync together to help the musician hear the playback as well on a louder speaker.

In some embodiments, the client device 102 creates its own music. In some embodiments, the client device 102 uploads to the created music to a music store.

In some embodiments, the client device 102 creates a mashup type of karaoke singing experience by combining lyrics or changing speed and tempo of the lyrics of the music piece. The lyrics may be mashed for gaming purposes based on music preference and music library. The client device 102 may mash or mix notes and lyrics to perform new tracks and create new music.

In some embodiments, the client device 102 displays and/or streams emoticons. In some embodiment, musicians may alter sheet notes and the client device 102 analyzes the sound of the altered sheet notes to match a melody of the music piece.

In some embodiments, the client device 102 analyzes voice patterns and may provide, to a performer, the right tone, pitch, and tempo of the music. In some embodiments, a singer may practice singing musical notes with different pitches, tempos and vocals. The client device 102 may have a microphone that receives the notes the singer is singing. The client device 102 may analyze the received notes and compare them to a standard register of notes and/or pitches. The client device 102 may present feedback as to how accurate the singer is performing with respect to the standard register of notes and/or pitches.

In some embodiments, the client device 102 may permit a performer to make adaptations or changes to the software by making changes to musical notes or lyrics they are viewing and the ability for them to interact with and alert the system to make these updates.

In some embodiments, song lyrics may be purchased or modified through the client device 102 to accept commands regarding the modification of lyrics or musical notes. The commands can come from an array of devices including wire and wireless devices or internet device such as computers, smart phone, digital handset, tablet, digital watch, etc.

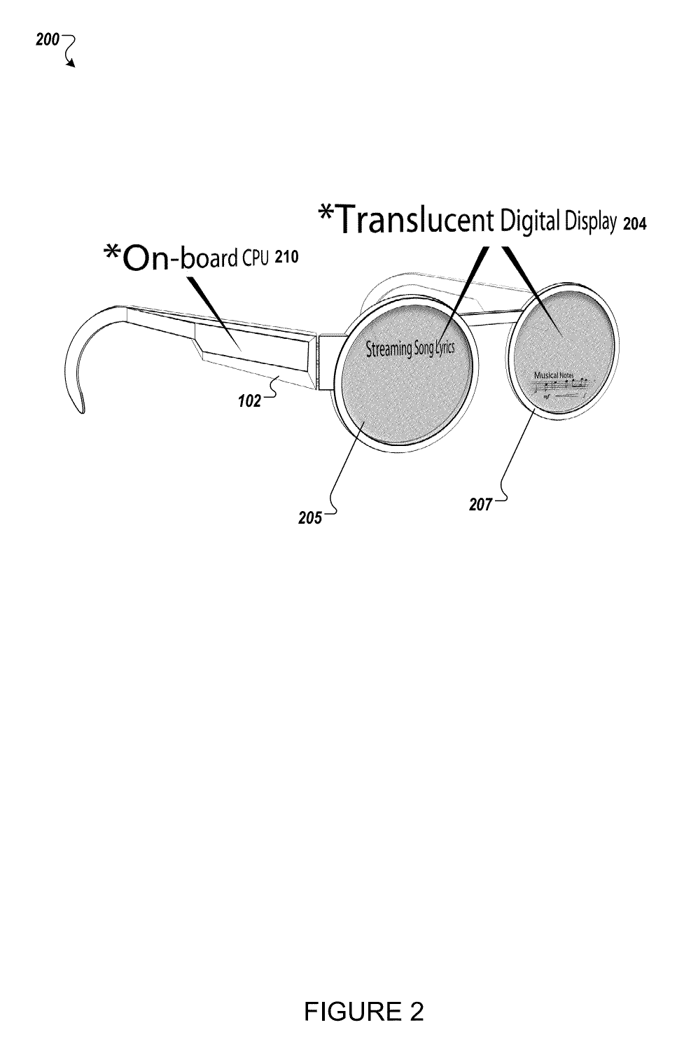

FIG. 2 illustrates an example client device 102 from FIG. 1 (illustrated as digital glasses) that have translucent lenses 110 to display music information. In FIG. 2, lyrics 205 are displayed and streamed on the client device 102 (e.g., digital glasses or specialized polarized and or translucent lens 204). A user can engage and view the lyrics to songs by wearing the client device 102. The client device 102 includes an on-board circuit board, chip or central processing unit (CPU) 210. The client device 102 also includes memory that may be used to store music information (e.g., musical lyrics 205 and notes 207). The client device 102 can receive music information in real time (e.g., streaming) or can receive all or part of the music information prior to playback of a music piece.

The lens 110 can present both lyrics 205 and musical notes 207 (e.g., sheet music) in synchronization. Alternatively, the lens 110 may present either the lyrics or the musical notes. In some embodiments, a performer may prefer to view both the lyrics 205 and the sheet music 207 at the same time so they can gauge the pitch, tone and melody of a music piece, verse or sound of music. This aids the performer in performing musical instruments in harmony and sync and provides a singer the ability to see the way the sheet music or background music was performed and the ability to make changes or adaptations as necessary.

In some embodiments, the client device 102 includes a microphone that receives the performer's performance. The client device 102 may include logic to make adaptations or adjustments based on users keynote stroke or string movement or vibrations while playing the instrument even feedback that a digital instrument would convey feedback to the client device 102.

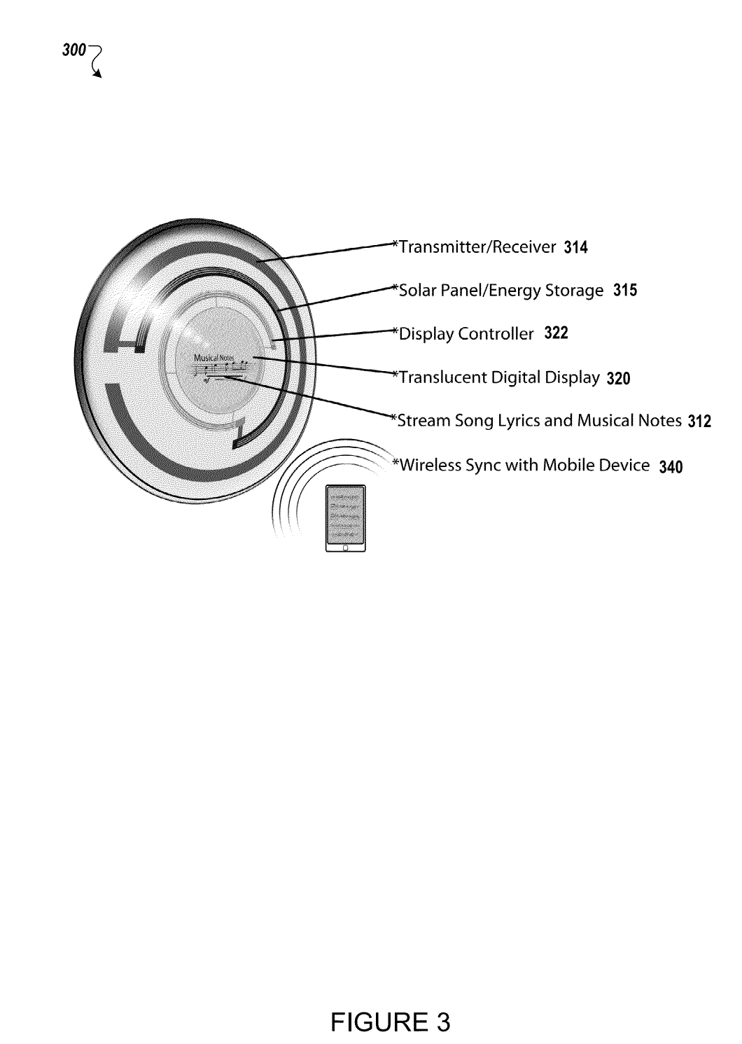

FIG. 3 illustrates an example contact lens 300 with musical lyrics and/or musical notes 312 being streamed and displayed on the lens 300. The lens 300 may be the client device 102 of FIG. 1. The example contact lens 300 may be an iOptiks™ contact optical lenses from Innovega Inc. of Bellevue, Wash. The contact lens 300 may include a memory to store software related to presenting music information through the contact lens 300. The lens 300 also may sync, receive, exchange, and/or modify the music information through none limiting sources such as a IR transmitter receiver 314, a solar projectile 315 that can store data, a display device 320 and a display control device 322 that allows modifications or access to the data. The lens 311 may receive modified instructions from an IR transmitter, a Bluetooth device, a wireless connective device 340, a wired connective device, or through an onboard processor that is in tune with the performer's voice.

The client device 102 may present both lyrics and musical notes at the same time. Alternatively, the lens may present either the lyrics or musical notes, depending on a user's particular needs and requirements. The lens 311 may also include a wireless sync component 316 that connects to the lens 311 to another device (e.g., another client device 102 or a content host). The lens may transmit and receive the music information between the other device via the wireless sync component 316.

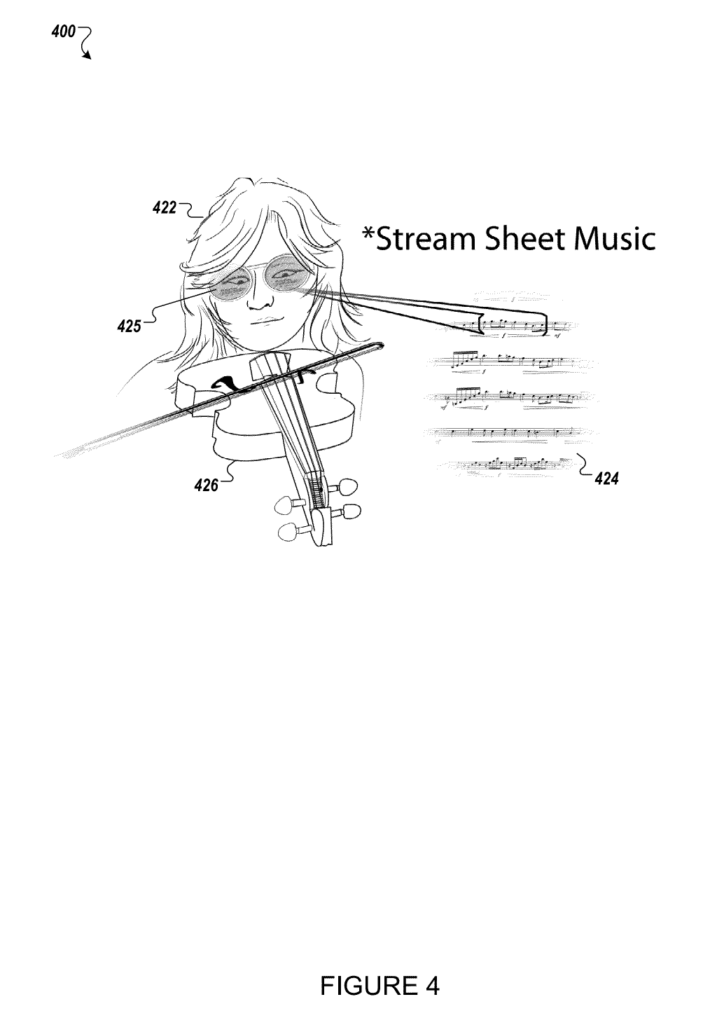

FIG. 4 illustrates an example musician 422 reading digital music sheet 424 streamed on a lens of her glasses 425 (e.g., client device 102 of FIG. 1), while she plays the violin 426, a musical instrument. The lens presents the digital music sheet 424 to allow the performer 422 to concentrate at close range and further practice and play her instrument 426.

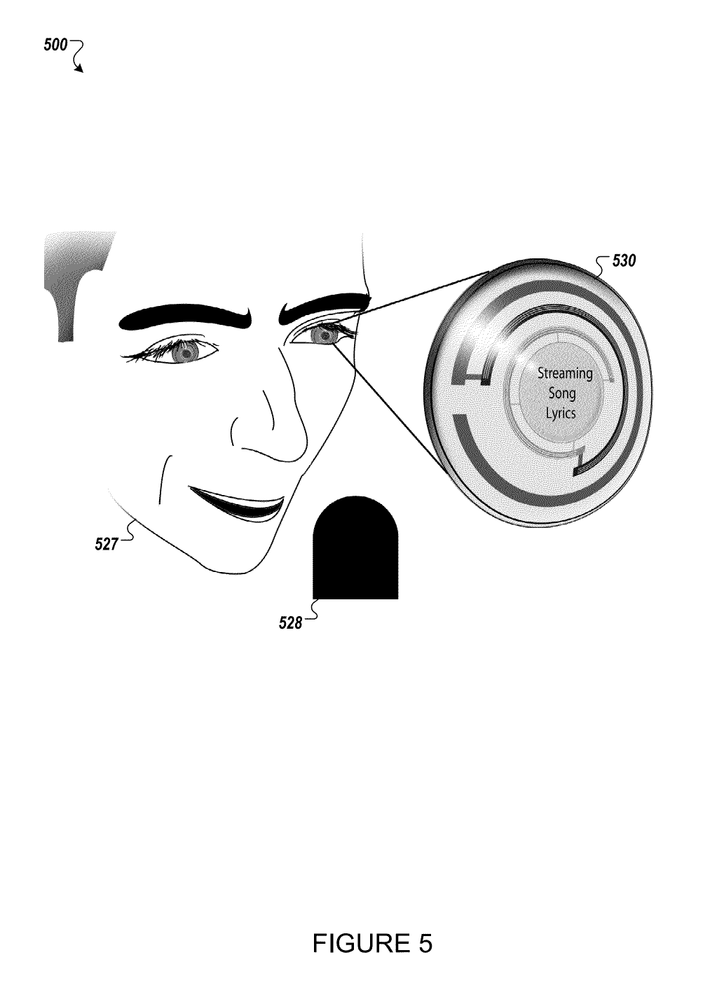

FIG. 5 illustrates a singer 527 wearing an optical lens 530 (e.g., client device 102 of FIG. 1) that presents digital lyrics to a song. The singer 527 sings into a microphone 528 while the lens 530 presents the lyrics and aid the singer in his performances. The lens 530 knows the tempo and speed of lyrics based on the metadata associated with the music piece receives from the users play list, a website, a music catalog, a music database, on board computer on the glasses, smart phone or tablet.

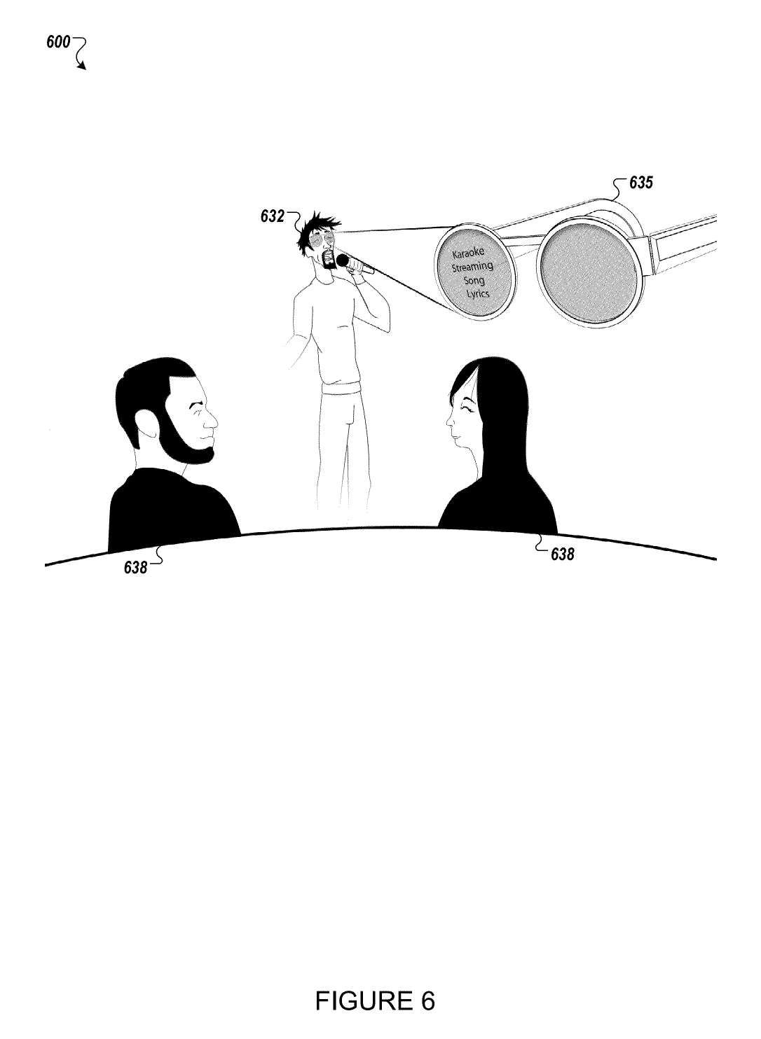

FIG. 6 illustrates a singer 632 wearing digital glasses 635 (e.g., client device 102 of FIG. 1) that include a media viewer (e.g., a musical software program such as the media viewer 112 of FIG. 1) to stream lyrics for entertainment and gaming purposes. The singer 632 sings along to the tunes in a karaoke style as a way to entertain and amuse his friends and colleagues 638. The streaming lyrics software on the glasses 635 allows the singer 632 to see and recite lyrics at close range without having to strain his vision.

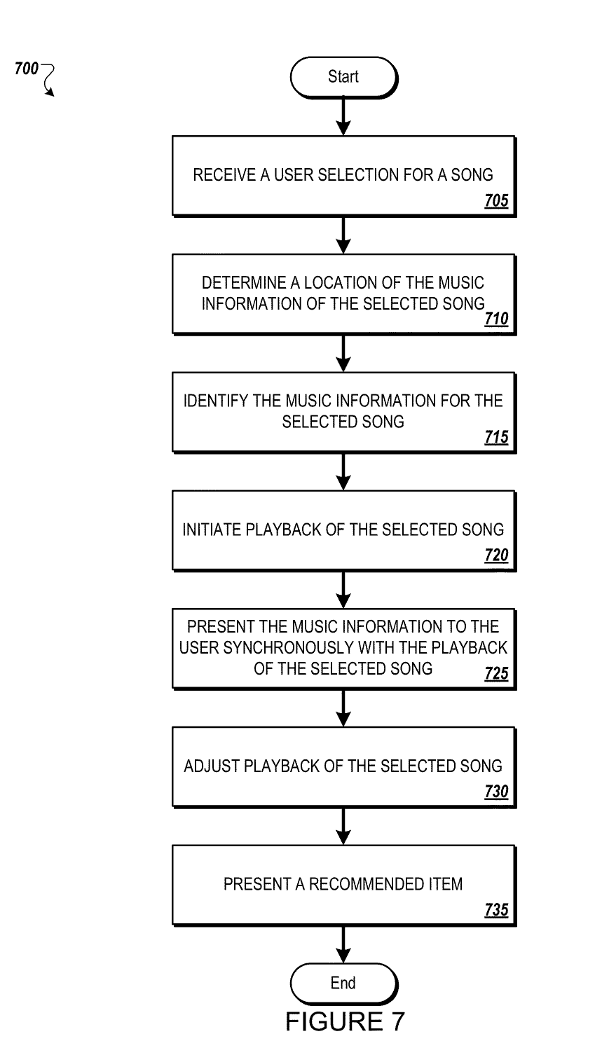

FIG. 7 is a flow diagram illustrating a method 700 for providing musical information in an optical display, in accordance with some embodiments. The method 700 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 700 may be performed by the client device 102 of FIG. 1.

Referring to FIG. 7, method 700 begins at block 705 when processing logic receives a user selection for a song. The user selection may be in the form of an audible selection (e.g., a performer's voice), a selection from a user interface, or a randomized selection of a song.

At block 710, the processing logic checks an internal memory to determine whether the internal memory includes music information for the song selected at block 705. The processing logic may retrieve the music information from a remote source (e.g., the Internet), or media player or network memory device or from wireless network or home computer or server, tablet, PC or smart phone or any smart device.

At block 715, the processing logic identifies the music information for the selected song, which was received either from internal memory or from another source, such as a content host 120 of FIG. 1.

At block 720, the processing logic optionally initiates playback of the selected song. The processing logic may initiate playback of the selected song in response to an explicit user selection to begin playback (e.g., voice command, button press, blink of an eye). In some embodiments, the processing logic initiates playback once it has identified and retrieved the music information.

At block 725, the processing logic presents the music information to the user synchronously with the playback of the selected song. The processing logic may use the speed and tempo that were in the song metadata when presenting the music information via the lens. In some embodiments, the processing logic presents the music information that is associated with the selected song in response to another device that begins playback of the selected song. For example, when a karaoke machine plays the song, the processing logic can detect when the karaoke machine begins playback and can then present the music information to the user synchronously with the playback of the selected song.

At block 730, the processing logic optionally receives a user input to adjust playback of the selected song, (e.g., stop, pause, rewind, fast forward, skip forward or backward, slow down, speed up, etc.). The processing logic then adjusts playback of the music piece in response to the input received above.

At block 735, the processing logic optionally presents a recommended playlist. In some embodiments, the processing logic creates a new playlist based on the selected song. In other embodiments, the processing logic uses an existing playlist.

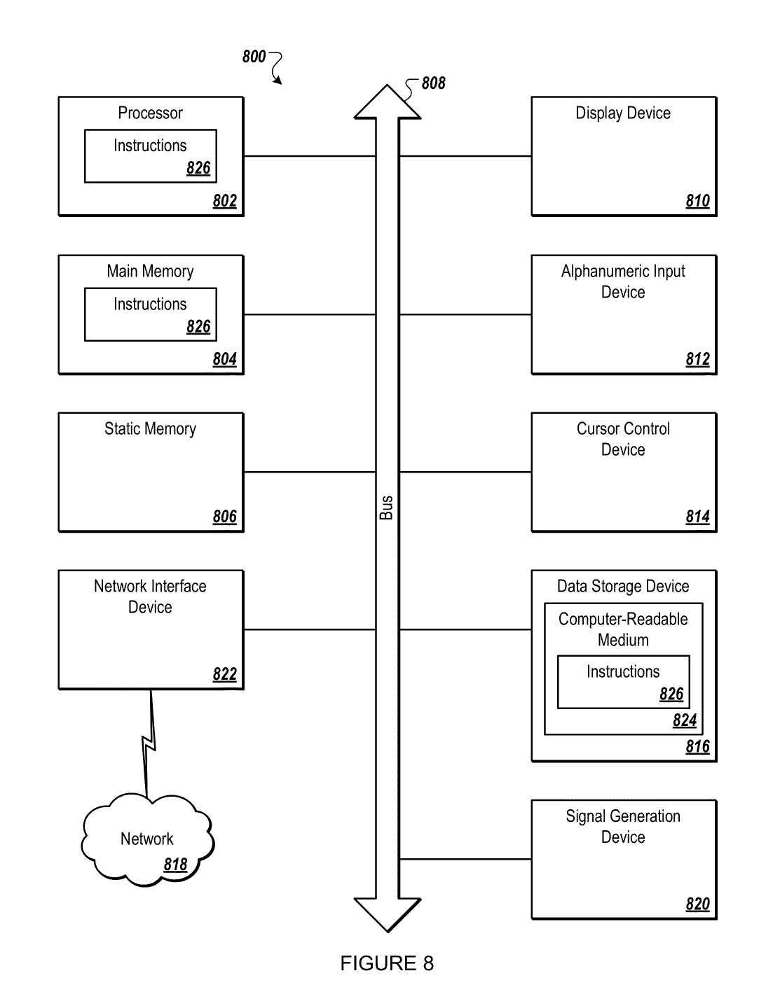

FIG. 8 illustrates a diagrammatic representation of a machine in the example form of a computer system 800 within which a set of instructions 826, for causing the machine to perform any one or more of the operations or methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the operations or methodologies discussed herein.

The example computer system 800 includes a processing device (processor) 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 816, which communicate with each other via a bus 808.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute instructions 826 for performing the operations and methodologies discussed herein.

The computer system 800 may further include a network interface device 822. The computer system 800 also may include a video display unit 810 (e.g., a liquid crystal display (LCD), a cathode ray tube (CRT), or a touch screen), an alphanumeric input device 812 (e.g., a keyboard), a cursor control device 814 (e.g., a mouse), and a signal generation device 820 (e.g., a speaker).

The data storage device 816 may include a computer-readable storage medium 824 on which is stored one or more sets of instructions 826 (e.g., software) embodying any one or more of the methodologies or functions described herein. The instructions 826 may also reside, completely or at least partially, within the main memory 804 and/or within the processor 802 during execution thereof by the computer system 800, the main memory 804 and the processor 802 also constituting computer-readable storage media. The instructions 826 may further be transmitted or received over a network 818 via the network interface device 822.

In one implementation, the instructions 826 include instructions for a providing one or more dynamic media players, which may correspond, respectively, to the media viewer 112 with respect to FIG. 1, and/or a software library containing methods that provide one or more dynamic media players for a content sharing platform. While the computer-readable storage medium 824 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

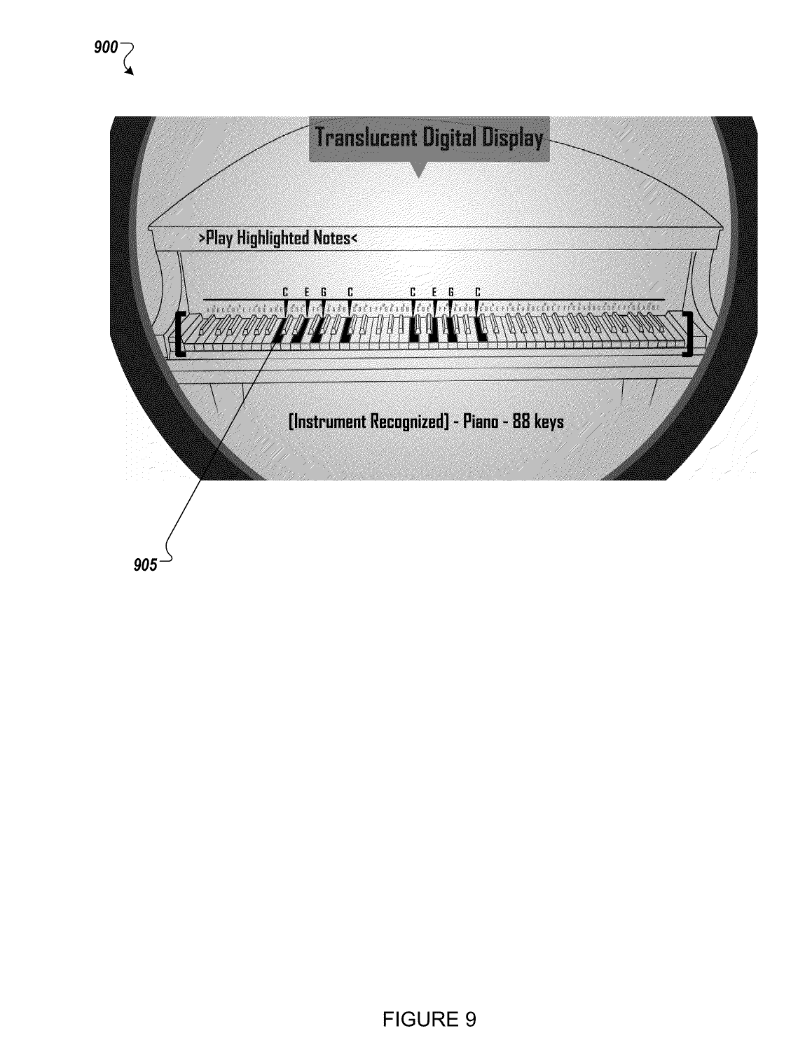

FIG. 9 illustrates an example view through translucent digital display 900 (e.g., a client device 102 of FIG. 1), according to some embodiments. The translucent digital display 900 presents in augmented reality. As illustrated, the translucent digital display 900 instructs a performer how to play a song on a piano. The translucent digital display 900 presents highlights 905 on the keys on the piano that the performer should play. In some embodiments, the translucent digital display 900 includes logic to recognize an instrument (e.g., the piano) and then obtain information related to that instrument (e.g., 88 keys of the piano).

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “presenting”, “scrolling”, “determining”, “enabling”, “preventing,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying an indication that a music piece is to begin playback;
identifying music information associated with the music piece; and
presenting, via an optical lens, the music information in synchronization with playback of the music piece.

2. The method of claim 1, wherein the music information comprises at least one of: lyrics associated with the music piece, or musical notes associated with the music piece.

3. The method of claim 1, wherein presenting the music information in synchronization with playback of the music piece comprises presenting new music information as the music piece continues to play.

4. The method of claim 3 further comprising:
receiving an indication that playback of the music piece is to stop at a stop position; and
stopping the presentation of the new music information such that the new music information being presented via the optical lens corresponds with the stop position of the stopped music piece.

5. The method of claim 1 further comprising initiating playback of the selected song in at least one speaker.

6. The method of claim 1 further comprising receiving a user input to begin playback of the selected song via an optical device that is associated with the optical lens.

7. The method of claim 6, wherein the user input comprises a movement of at least one of: an eye of the user or an eye lid of the user.

8. A system comprising:
a memory;
a processing device coupled to the memory, the processing device to perform operations comprising:
identify an indication that a music piece is to begin playback;
identify music information associated with the music piece; and
present, via an optical lens, the music information in synchronization with playback of the music piece.

9. The system of claim 8, wherein the music information comprises at least one of: lyrics associated with the music piece, or musical notes associated with the music piece.

10. The system of claim 8, wherein presenting the music information in synchronization with playback of the music piece comprises presenting new music information as the music piece continues to play.

11. The system of claim 8, wherein the processing device is further to execute operations comprising:
receive an indication that playback of the music piece is to stop at a stop position; and
stop the presentation of the new music information such that the new music information being presented via the optical lens corresponds with the stop position of the stopped music piece.

12. The system of claim 8 further comprising receiving a user input to begin playback of the selected song via an optical device that is associated with the optical lens.

13. The method of claim 6, wherein the user input comprises a movement of at least one of: an eye of the user or an eye lid of the user.

14. A non-transitory machine-readable storage medium storing instructions which, when executed, cause a processing device to perform operations comprising:
identifying an indication that a music piece is to begin playback;
identifying music information associated with the music piece; and
presenting, via an optical lens, the music information in synchronization with playback of the music piece.

15. The non-transitory machine-readable storage medium of claim 14, wherein the music information comprises at least one of: lyrics associated with the music piece, or musical notes associated with the music piece.

16. The non-transitory machine-readable storage medium of claim 14, wherein presenting the music information in synchronization with playback of the music piece comprises presenting new music information as the music piece continues to play.

17. The non-transitory machine-readable storage medium of claim 14, the operations further comprising:
receiving an indication that playback of the music piece is to stop at a stop position; and
stopping the presentation of the new music information such that the new music information being presented via the optical lens corresponds with the stop position of the stopped music piece.

18. The non-transitory machine-readable storage medium of claim 14, the operations further comprising initiating playback of the selected song in at least one speaker.

19. The non-transitory machine-readable storage medium of claim 14, the operations further comprising receiving a user input to begin playback of the selected song via an optical device that is associated with the optical lens.

20. The non-transitory machine-readable storage medium of claim 19, wherein the user input comprises a movement of at least one of: an eye of the user or an eye lid of the user.
